(19) United States
(12) Patent Application Publication
(10) Pub. No.: US 2003/0123149 A1
(43) Pub. Date: Jul. 3, 2003

(54) Method of producing low birefringence polycarbonate film assemblies

(75) Inventors: Kang Xi, Terre Haute, IN (US); James J. Scobbo JR., Evansville, IN (US)

Correspondence Address: Robert E. Walter, GE Plastics, One Plastics Avenue, Pittsfield, MA, 01201, US

(73) Assignee: General Electric Company

(21) Appl. No.: 10/303,314

(22) Filed: Nov. 26, 2002

Related U.S. Application Data
(60) Provisional application No. 60/344,268, filed on Dec. 27, 2001.

(51) Int. Cl. G02B 5/30; B29D 11/00

(52) U.S. Cl. 359/497; 264/1.33; 264/1.7

(57) ABSTRACT

A method of producing a polycarbonate film for optical recording media is provided. The polycarbonate film includes a plurality of layers, and the method includes arranging the plurality of layers so that a principal optical axis of a first layer is at an angle greater than zero degrees from a principal optical axis of a second layer.

### CROSS-REFERENCE TO RELATED APPLICATIONS

THIS APPLICATION IS RELATED TO AND CLAIMS PRIORITY FROM PROVISIONAL APPLICATION No. 60/344,268 FILED ON DEC. 27, 2001, THE ENTIRE CONTENTS OF WHICH ARE INCORPORATED

### BACKGROUND OF THE INVENTION

This invention, relates generally to the production of polycarbonate films, and more particularly to the production of low birefringence multi-layer polycarbonate films for optical recording media.

In optical recording media such as optical cards and optical discs, for example CDs and DVDs, optically detectable minute pits of several micometers in diameter, or fine spiral grooves are formed as a track on a thin recording layer provided on a substrate of, for example, polycarbonate. In such optical recording media, a laser beam scans along the track when the information is recorded and reproduced. Typically, the laser beam must pass through the polycarbonate substrate, and thus the characteristics of the polycarbonate substrate can effect the laser beam. For example, stress, and thus birefringence, in the plastic substrate can cause laser signal attenuation during optical recording/reading in data storage applications

As a form of optical distortion, birefringence is an important factor for system design in many applications such as optical data storage devices. Birefringence is an optical measure of material stress, most simply defined as the difference in refractive index between any two principle axes of the optical ellipsoid through which light passes. It affects the phase relationship of laser light and causes deteriorated interference degrading the quality of the modulated light. As a result, birefringence causes reduced signal response from an optical pickup. The amount of birefringence in plastic material is related to its inherent optical properties but more importantly to the residual stress caused by the production process, such as, injection molding and calendering.

### BRIEF DESCRIPTION OF THE INVENTION

In one aspect, a method of producing a polycarbonate film for optical recording media is provided. The polycarbonate film includes a plurality of layers, and the method includes arranging the plurality of layers so that a principal optical axis of a first layer is at an angle greater than zero degrees from a principal optical axis of a second layer.

In another aspect, a method of modulating birefringence in a polycarbonate film for optical recording media is provided. The polycarbonate film includes a plurality of layers, and the method includes laminating the plurality of layers so that a principal optical axis of a first layer is at an angle greater than zero degrees from a principal optical axis of a second layer.

In another aspect, a method of producing a polycarbonate film having a controlled birefringence for optical recording media is provided. The polycarbonate film includes a plurality of layers, and the method includes laminating a first extruded polycarbonate film layer to a second extruded polycarbonate film layer so that a principal optical axis of the first film layer is at an angle greater than zero degrees from a principal optical axis of the second film layer.

In another aspect, a method of producing a low birefringence polycarbonate film for optical recording media is provided. The polycarbonate film includes a plurality of layers, and the method includes laminating a first injection molded disc layer and a second extruded polycarbonate film layer so that an angle between a principal optical axis of the first layer and a principal optical axis of the second layer varies continuously from 0 to 360 degrees.

In another aspect, a polycarbonate film, having a controlled birefringence, for optical recording media is provided. The polycarbonate film includes a plurality of layers configured so that a principal optical axis of a first layer is at an angle greater than zero degrees from a principal optical axis of a second layer.

### BRIEF DESCRIPTION OF THE DRAWINGS

FIG. 1 is perspective view and an exploded side view of a compact disc (CD).

FIG. 2 is a schematic view of a two layer polycarbonate substrate layer in accordance with an embodiment of the present invention.

FIG. 3 is graphic representation of the components, of a circular polarized light beam.

FIG. 4. is a graphic representation of optical axis of first and second polycarbonate layers of a two layer polycarbonate substrate.

FIG. 5 is a graph of percent loss of light versus retardation.

FIG. 6 is a graph of percent loss of light versus an angle between optical axis of the two layers of a two layer polycarbonate substrate.

FIG. 7 is a graph of percent loss of light versus an angle between optical axis of the two layers of a two layer polycarbonate substrate.

FIG. 8 is a graph of equivalent retardation versus optical axis angle for a two layer polycarbonate substrate made from an extruded film layer and an injection molded disc layer.

### DETAILED DESCRIPTION OF THE INVENTION

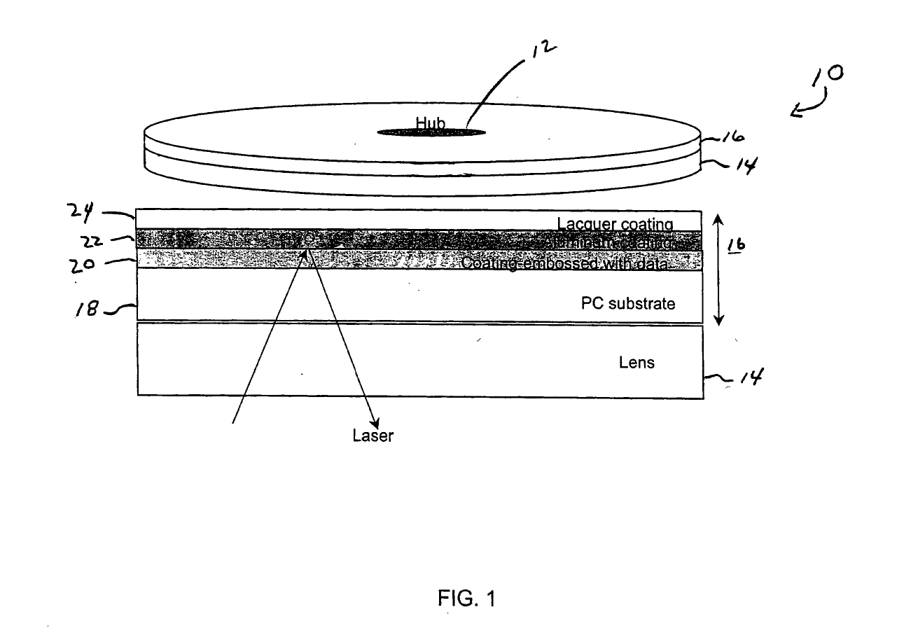

FIG. 1 shows the structure of a known CD 10 which is representative of optical recording media. CD 10 is disc shaped having a hub 12 at its center. CD 10 includes a lens portion 14 attached to a data storage portion 16. Data storage portion 16 includes a polycarbonate substrate layer 18 on which a coating layer 20 embossed with read/write data is deposited. An aluminum coating layer 22 is deposited on top of embossed coating layer 20, and a protective coating layer 24 is deposited on top of aluminum layer 22 for scratch and abrasion resistance. In a CD read/write machine, a laser beam 26 is directed through lens 14 and polycarbonate substrate layer 18 into embossed data layer 20 where it is reflected back through the layers to an optical pickup head (not shown). Birefringence is an optical measure of material stress, most simply defined as the difference in refractive index between any two principle axes of the optical ellipsoid through which light passes. Birefringence in polycarbonate substrate layer 18 affects the phase relationship of laser light beam 26 and causes deteriorated interference degrading the quality of the modulated light. As a result, birefringence in polycarbonate substrate layer 18 causes reduced signal response from an optical pickup. The amount of birefringence in polycarbonate substrate layer 18 is related to its inherent optical properties but more importantly to the residual stress caused by its manufacturing process such as injection molding and calendering.

Polycarbonate substrate layer 18 of CD 10 can be formed from an extruded polycarbonate film or an injection molded disc. In one embodiment, polycarbonate substrate layer 18 is formed from a thermoplastic polycarbonate material, such as Lexan® resin, commercially available from General Electric Company, Schenectady, N.Y. The thermoplastic polycarbonate resins that may be employed in producing polycarbonate substrate layer 18, include without limitation, aromatic polycarbonates, copolymers of an aromatic polycarbonate such as polyester carbonate copolymer, blends thereof, and blends thereof with other polymers depending on the end use application. In one embodiment, the thermoplastic polycarbonate resin is an aromatic homo-polycarbonate resin and examples of such polycarbonate resins are described in U.S. Pat. No. 4,351,920. They are obtained by the reaction of an aromatic dihydroxy compound with a carbonyl chloride. Other polycarbonate resins may be obtained by the reaction of an aromatic dihydroxy compound with a carbonate precursor such as a diaryl carbonate. A preferred aromatic dihydroxy compound is 2,2-bis(4-hydroxy phenyl) propane (i.e. Bisphenol-A). A polyester carbonate coplymer is obtained by the reaction of a dihydroxy phenol, a carbonate precursor and dicarboxylic acid such as terephthalic acid or isophthalic acid or a mixture of terephthalic and isophthalic acid. Optionally, an amount of a glycol may also be used as a reactant.

As mentioned above, birefringence can affect the ability to accurately measure the intensity and polarization of a light and result in reading error in data storage devices. One of the ways to characterize the effect of birefringence on the optical path is to measure the loss of light intensity, that is the readout light intensity with respective to the intensity from a perfect substrate without birefringence. The case of an extruded film is different from an injection molded disc in terms of optical axis orientation. In the injection molded disc, the macromolecules orient in the radial direction, so the optical axes are the radial (RD) and tangential directions, and in-plane birefringence is the difference in refractive index in these two directions. In the case of an extruded film, the molecules orient in the machine direction during calendering, therefore, the optical axes are the machine direction (MD) and transverse direction (TD).

In an exemplary embodiment of the present invention, polycarbonate substrate layer 18 is formed from a plurality of layers of polycarbonate. Specifically, polycarbonate layer 18 is formed from at least two layers of polycarbonate of which one layer is an extruded polycarbonate film. In one exemplary embodiment, polycarbonate substrate layer 18 is formed from two extruded polycarbonate film layers. In another exemplary embodiment, polycarbonate layer 18 is formed from one polycarbonate injection molded disc layer and one extruded polycarbonate film layer.

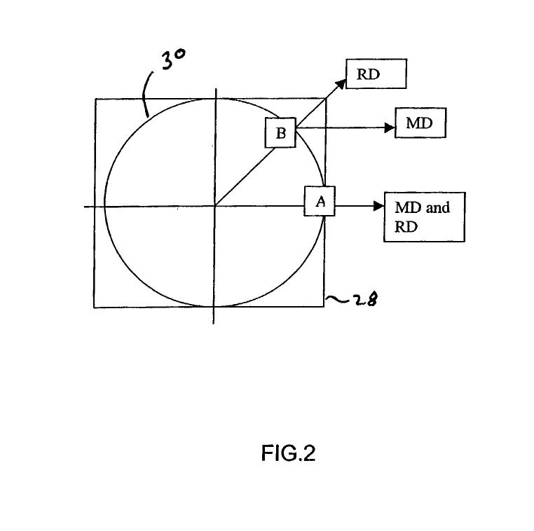

The analysis of birefringence effects becomes more complicated in a two-layer structure such as two extruded polycarbonate film layers or one polycarbonate injection molded layer and one extruded polycarbonate film layer. In this case, in addition to the difference of the orientation of the principal optical axis in each layer, the angle between optical axes in the extruded film and injection molded disk changes at different location of the assembly. FIG. 2 shows the relationship of an optical axis angle between an extruded film 28 (square) and injection molded disc 30 (round). In location A, the machine direction is the same as radial direction, in location B, the machine direction and radial direction is different.

In the analysis described below, a test optical system similar to most CD/DVD devices is used. Specifically, in the test apparatus, a linear polarized light passes through a ¼ wavelength plate (at 45 degree angle to the optical axis) to generate circular polarized light. The circular polarized light travels through the substrate (e.g. the extruded polycarbonate film or injection molded polycarbonate disc) and then goes through another ¼ wave plate. The out-coming light intensity, I₄₅, is measured at 45 degree to the optical axis of the ¼ wavelength plate.

Considering a linearly polarized light, Eₒ Sin(ωt), passing through a quarter wavelength plate at 45 degree, the light becomes circular polarized with component Ex and Ey as follows:

Ex=Eₒ sin 45 sin(ωt)=E sin(ωt) (1)

Ey=Eₒ sin 45 sin(ωt)=E sin(ωt+π/2) (2)

Where

E=Eₒ sin 45 (3)

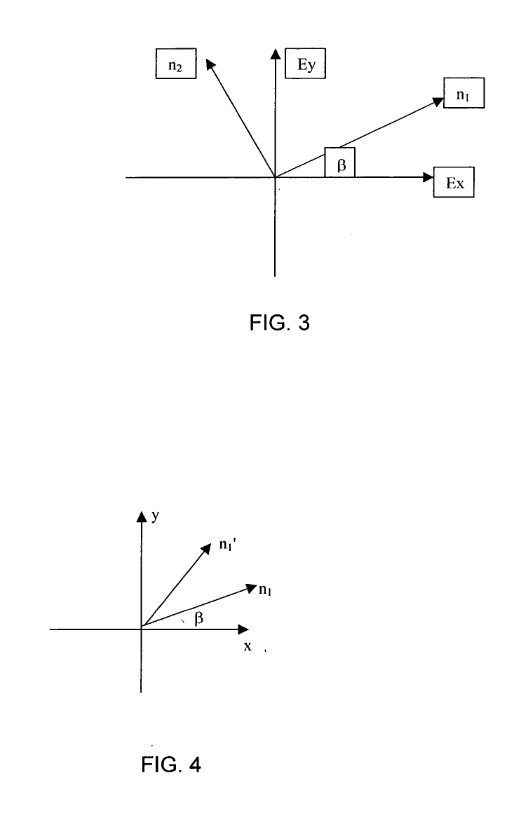

Then the light goes through the sample with optical axis n₁ at β angle with respect to Ex as shown in FIG. 3.

Before entering the sample, the light components can be expressed in the optical axes as:

En₁=Ex cos β+Ey sin β (4)

En₂=Ey cos β−Ey sin β (5)

With Equations 1-3, Equations 4 and 5 can be re-written as:

En₁=E sin(ωt+β) (6)

En₂=E cos(ωt+β)=E sin(ωt+β+π/2) (7)

After passing through the sample, the phase relationship changes due to birefringence in the sample and light components become:

En₁=E sin(ωt+β) (8)

En₂=E sin(ωt+β+π/2+φ) (9)

Where φ is the phase retardation given by:

Φ=2πR/λ (10)

where λ is the wavelength of the light and R is retardation given by

R=Δnd (11)

where Δn is the refractive index difference between n1 and n2, and d is the thickness of the sample.

The light becomes elliptic (see FIG. 4) and can be written as:

$$\frac{{Ex}^{′}}{{a}^{2}} + \frac{{Ey}^{′}}{{b}^{2}} = 1 \qquad ( 12 )$$

the angle α between Ex′ and Ex is given by:

α=β−π/4 (13)

$${a}^{2} = \frac{{cos}^{2} ϕ}{1 - sin ϕ} , {b}^{2} = \frac{{cos}^{2} ϕ}{1 + sin ϕ} \qquad ( 14 )$$

The light then enter the second quarter wavelength plate with optical axes in the x and y direction. The light components in the x and y axes before entering the quarter wavelength plate are:

Ex=En₁ cos β−En₂ sin β (15)

Ey=En₁ sin β+En₂ cos β (16)

With Equations 8 and 9, Equations 15 and 16 become:

Eₓ=EK₁ sin(ωt+A₁) (17)

E_{y}=EK₂ sin(ωt+A₂) (18)

Where

K₁²=1+sin 2β sin φ (19)

K₂²=1−sin 2β sin φ (20)

$$\begin{matrix}tan {A}_{1} = \frac{cos β sin β - sin β cos ( β + φ )}{cos βcos β + sin β sin ( β + φ )} & ( 21 ) \\ tan {A}_{2} = \frac{sin β sin β + cos β cos ( β + φ )}{sin β cos β - cos βsin ( β + φ )} & ( 22 )\end{matrix}$$

After passing through the quarter wavelength plate, the light components are:

Eₓ=EK₁ sin(ωt+A₁) (23)

E_{y}=EK₂ sin(ωt+A₂+π/2) (24)

The out-coming light with polarization direction at 45 degree to the Ex is called E₄₅, which is given by:

E₄₅=sin 45(Ex+Ey) (25)

With Equations 3, 23 and 24, Equation 19 can be re-written as:

$$\begin{matrix}{E}_{45} = \frac{1}{2} {E}_{0} K sin ( ω t + A ) & ( 26 ) \\ \begin{matrix}{K}^{2} = {K}_{1}^{2} + {K}_{2}^{2} + 2 {K}_{1} {K}_{2} cos ( {A}_{2} - {A}_{1} + π / 2 ) where \\ = 2 ( 1 - cos φ ) = 4 {sin}^{2} ( \frac{φ}{2} )\end{matrix} & ( 27 )\end{matrix}$$

With Equation 26, the light intensity at 45 degree, I₄₅, is given by:

$${I}_{45} = \frac{1}{4} {I}_{0} {K}^{2} = {I}_{0} {sin}^{2} \frac{φ}{2} = {I}_{0} {sin}^{2} π \frac{R}{λ} \qquad ( 28 )$$

where R is retardation given by Equation 11 and λ is the light wavelength.

In an exemplary embodiment, where light travels through an injection molded disc layer first, and then passes through an extruded film layer, after passing through the first injection molded disc layer with n₁ and n₂ as optical axes, the light components in n₁ and n₂ direction can be written as (see Equations 8 and 9):

En₁=E sin(ωt+β) (29)

En₂=E sin(ωt+β+/2+φ₁) (30)

Where phase shift φ₁ is related to the retardation of layer 1 as:

Φ₁=2πR₁/λ (31)

In the second extruded film layer, the optical axes are n₁′ and n₂′ and the angle between n₁ and n₁′ is γ, and β is the angle between n₁ and the x axis as shown in FIG. 4.

Before entering the second extruded film layer, the light components in n₁′ and n₂′ directions are:

En₁′=En₁ cos γ+En₂ sin γ=EK₁ sin(ωt+A₁) (32)

En₂′=En₂ cos γ−En₁ sin γ=EK₂ sin(ωt+A₂) (33)

Where K₁=1−sin 2γ sin φ₁ and K₂=1+sin 2γ sin φ₁ (34)

$$\begin{matrix}And tan {A}_{1} = \frac{cos γ sin β + sin γ cos ( β + {φ}_{1} )}{cos γ cos β - sin γ sin ( β + {φ}_{1} )} & ( 35 ) \\ tan {A}_{2} = \frac{cos γ cos ( β + {φ}_{1} ) - sin γ sin β}{- cos γcos ( β + {φ}_{1} ) - sin γ cos β} & ( 36 )\end{matrix}$$

After passing through the second layer, the light components become:

En₁′=En₁ cos γ+En₂ sin γ=EK₁ sin(ωt+A₁) (37)

En₂′=En₂ cos γ−En₁ sin γ=EK₂ sin(ωt+A₂+φ₂) (38)

Where Φ₂=2πR₂/λ (39)

Before entering the second quarter wavelength plate, the light components in x and y directions are:

Ex=En₁′ cos(β+γ)−En₂′ sin(β+γ)=EK₃ sin(ωt+B₁) (40)

Ey=En₁′ sin(β+γ)+En₂′ cos(β+γ)γ=EK₄ sin(ωt+B₂) (41)

Where

K₃²=K₁² cos²(β+γ)+K² sin²(β+γ)−K₁K₂ sin 2(β+γ)cos(A₂−A₁+φ₂) (42)

K₄²=K₁² sin²(β+γ)+K₂² cos²(β+γ)+K₁K₂ sin 2(β+γ)cos(A₂−A₁+φ₂) (43)

$$\begin{matrix}tan {B}_{1} = \frac{{K}_{1} cos ( β + γ ) sin {A}_{1} - {K}_{2} sin ( β + γ ) sin ( {A}_{2} + {φ}_{2} )}{{K}_{1} cos ( β + γ ) cos {A}_{1} - {K}_{2} sin ( β + γ ) cos ( {A}_{2} + {φ}_{2} )} & ( 44 ) \\ tan {B}_{2} = \frac{{K}_{1} sin ( β + γ ) sin {A}_{1} + {K}_{2} cos ( β + γ ) sin ( {A}_{2} + {φ}_{2} )}{{K}_{1} sin ( β + γ ) cos {A}_{1} + {K}_{2} cos ( β + γ ) cos ( {A}_{2} + {φ}_{2} )} & ( 45 )\end{matrix}$$

After passing through quarter wavelength plate, the light waves become:

Ex=EK₃ sin(ωt+B₁) (46)

Ey=EK₄ sin(ωt+B₂+π/2) (47)

Therefore, E₄₅ is given by:

$$\begin{matrix}{E}_{45} = sin 45 ( Ex + Ey ) = sin 45 E [ {K}_{3} sin ( ω t + {B}_{1} ) + \\ {K}_{3} sin ( ω t + {B}_{2} + π / 2 ) ] \\ = \frac{1}{2} {E}_{0} K sin ( ω t + C )\end{matrix} \qquad ( 48 )$$

where

$$\begin{matrix}{K}^{2} = {K}_{3}^{2} + {K}_{4}^{2} - 2 {K}_{3} {K}_{4} sin ( {B}_{2} - {B}_{1} ) \\ = 4 [ {sin}^{2} γ {sin}^{2} ( \frac{{φ}_{1} - {φ}_{2}}{2} ) + {cos}^{2} γ {sin}^{2} ( \frac{{φ}_{1} + {φ}_{2}}{2} ) ]\end{matrix} \qquad ( 49 )$$

The light intensity I₄₅ is given by:

$$\begin{matrix}{I}_{45} = \frac{1}{4} {I}_{0} {K}^{2} = {I}_{0} [ {sin}^{2} γ {sin}^{2} ( \frac{{φ}_{1} - {φ}_{2}}{2} ) + {cos}^{2} γ {sin}^{2} ( \frac{{φ}_{1} + {φ}_{2}}{2} ) ] \\ = {I}_{0} [ {sin}^{2} γ {sin}^{2} π ( \frac{{R}_{1} - {R}_{2}}{λ} ) + {cos}^{2} γ {sin}^{2} π ( \frac{{R}_{1} + {R}_{2}}{λ} ) ]\end{matrix} \qquad ( 50 )$$

The intensity of light whose polarization is perpendicular to E₄₅ is:

$$\overline{{I}_{45}} = {I}_{0} [ {sin}^{2} {γcos}^{2} π ( \frac{{R}_{1} - {R}_{2}}{λ} ) + {cos}^{2} {γcos}^{2} π ( \frac{{R}_{1} + {R}_{2}}{λ} ) ] \qquad ( 51 )$$

In a known CD where polycarbonate substrate layer 18 is one layer of polycarbonate, Equation 13-15 can be used to evaluate the ellipticity of light coming out of the sample. The angle α between the ellipsoid major axis a and axis x is determined by the angle β between optical axis of the sample and the axis x. In the injection molded disc, the radial direction is always the same as the x direction at the location of light spot, which means β=0 and α=−45 degree. For an extruded film, β changes with disk rotation, so the ellipsoid orientation also changes with the rotation. The light component along the major and minor axes of the ellipsoid is determined only by the phase shift due to sample retardation. When there is no retardation, φ=0 and then a=b. When φ=π/2 (equivelant to another quarter wavelength plate), then b=0, the light become linearly polarized again.

The ellipiticity of the light coming out of the second quarter wavelength plate can be determined by Equations 23 and 24. The angle α in this case is given by:

α=_{χ}/2−π/4 (52)

and

tan _{χ}=sin 2β*tan φ (53)

The major and minor axes are:

$${a}^{2} = \frac{{sin}^{2} {φcos}^{2} 2 β}{1 - sin 2 βcos 2 αsinϕ + sin 2 αcosφ} \\ {b}^{2} = \frac{{sin}^{2} {φcos}^{2} 2 β}{1 + sin 2 βcos 2 αsinϕ - sin 2 αcosφ} \qquad ( 54 )$$

So, the ellipiticity is a function of the angle β (between sample optical axis and optical axis of quarter wavelength plate) and sample retardation. In the case of β=0 (e.g. injection molded disc) with no retardation of the sample, the light is linearly polarized with polarization direction perpendicular to the original direction which is 45 degree to the x axis. When a sample has birefringence, the light coming out of the second quarter wavelength plate has two components: 45 degree light (original polarization) and 135 degree light (perpendicular to the original polarization). A typical CD optical system uses 135 degree light as a readout signal, and the 45 degree light adds to the original laser light. Therefore, the effect of birefringence reduces the readout light signal (135 degree light), and adds noise (the 45 degree light) to the in-coming laser light.

The light loss percentage can be evaluated using the 45 degree light denoted as I₄₅. With Equation 28, it shows that:

$$\frac{{I}_{45}}{{I}_{0}} = {sin}^{2} \frac{π R}{λ} \qquad ( 55 )$$

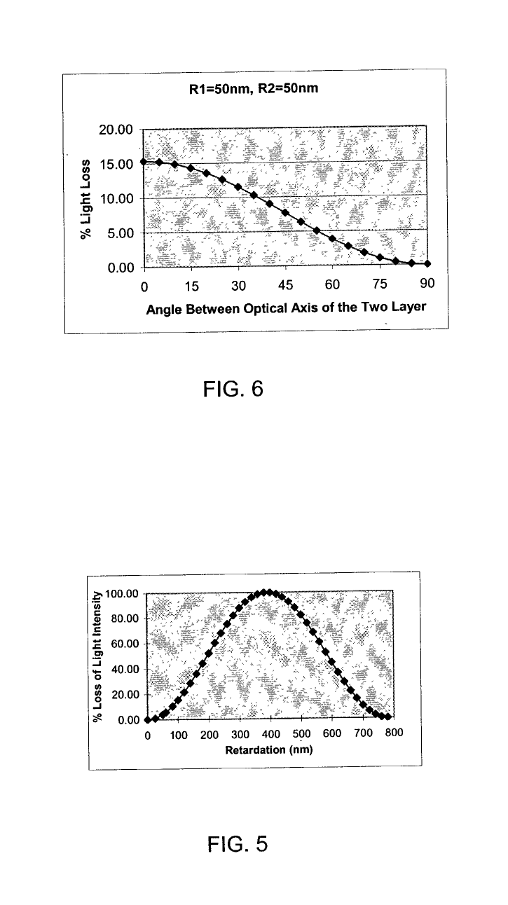

Equation 55 is the base for many birefringence or retardation measurement systems. By measuring the intensity of out-coming light with the same polarization as the initial in-coming light, which is 45 degrees to the optical axis of the quarter wavelength plate, the retardation R can be calculated using Equation 55. In the perfect case where there is no birefringence (R=0), I₄₅=0, there is no light loss. From Equation 55, one notices that the light loss is independent of the angle between sample optical axis and the optical axis of the quarter wavelength plate. This means with two quarter wavelength plates in the optical system, the effect of sample optical axis orientation can be eliminated. Therefore, the extruded film, in this case, has the same behavior as an injection molded disc in terms of light intensity loss due to birefringence. One can see that the loss of light intensity of readout signal is determined by the sample retardation and laser wavelength. FIG. 5 shows an example of light loss percentage at laser wavelength of 780 nm (CD players use the same wavelength). One can see there is a bell curve with a max light loss (100%) occurring at 390 nm wavelength. This means that when there is 180 degree phase shift due to sample retardation, all the light components have the same polarization direction as the original light, there is no light component perpendicular to the original light, therefore, no readout signal at all.

From Equation 50, the light intensity loss percentage can be evaluated as:

$$\frac{{I}_{45}}{{I}_{0}} = [ {cos}^{2} {γsin}^{2} π ( \frac{{R}_{1} + {R}_{2}}{λ} ) + {sin}^{2} {γsin}^{2} π ( \frac{{R}_{1} - {R}_{2}}{λ} ) ] \qquad ( 56 )$$

In an exemplary embodiment where polycarbonate substrate 18 is a two-layer assembly, one can see that the loss of light intensity depends on the angle (γ) between optical axis and the first layer and optical axis of the second layer. At γ=0 degree,

$$\frac{{I}_{45}}{{I}_{0}} = {sin}^{2} π ( \frac{{R}_{1} + {R}_{2}}{λ} ) ,$$

which means the total birefringence of the two-layer assembly is the sum of the first and second layers. At γ=90 degree,

$$\frac{{I}_{45}}{{I}_{0}} = {sin}^{2} π ( \frac{{R}_{1} - {R}_{2}}{λ} ) ,$$

which means that the assembly birefringence is determined by the birefringence difference between the first and second layer.

In one exemplary embodiment, polycarbonate substrate 18 is a two-layer assembly using two extruded films with principal optical axis perpendicular to each other. In this way, the assembly birefringence can be cancelled out by this 90 degree orientation effect. Particularly, if the two films are the same (R1=R2), then the assembly birefringence is zero no matter, how large the film birefringence is. In another embodiment, polycarbonate substrate 18 is a two-layer assembly using two extruded films which are positioned so that their principal optical axes are not parallel. Particularly, the optical axis of the first layer is at an angle greater than zero from the principal optical axis of the second layer.

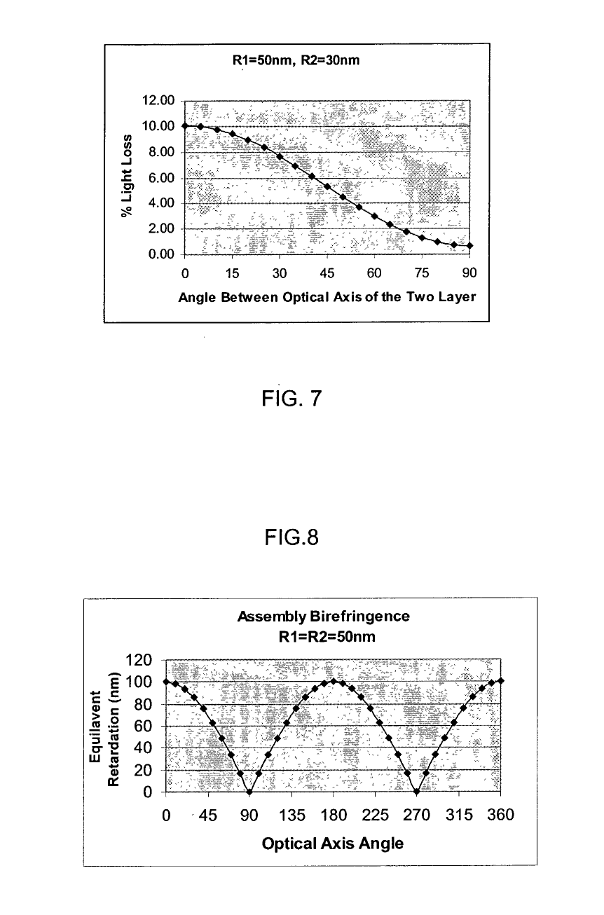

Equation 56 shows that both the sum and the difference of the retardation of the first and second layer contribute to the assembly light intensity loss at certain optical orientation angle γ. FIG. 6 shows an example of the light loss percentage as function of optical axis orientation angle with 50 nm retardation for both layers. One can see that the light loss decrease with optical orientation angle. At 0 degree, the assembly retardation is simply the sum of each layer, which is 100 nm, there is 15.6% light loss for the readout signal due to the sample birefringence. This is also the upper birefringence spec limit (100 nm) for typical CD applications. FIG. 7 shows the signal intensity loss with retardation of 50 nm for first layer and 30 nm for the second layer. One can see the total light loss is smaller as compared to FIG. 6, and there is a residual light loss at 90 degree due to the unequal birefringence of the first and second layers.

For a two-layer assembly using injection molded disc (disc+disc assembly), the total birefringence of the assembly always is the sum of the two layers (simple addition), because the optical axes of both layers are parallel (both in radial directions) at any location of the disc. For an assembly made from two extruded film layers, the optical axis orientation angle can be adjusted, and the assembly retardation can vary from maximum (addition) to minimum (subtraction) depend on the angle γ. For a assembly made from an injection molded disk and an extruded film (film+disc), the optical axis angle between the two layers varies continuously from 0 to 360 degree. The assembly retardation at any given point of the assembly therefore also varies according to Equation 56 as shown in FIG. 6. Since the light intensity loss for film+disc assembly varies with optical orientation angle, average light intensity loss can be used to characterize such system. The averaged loss of light can be obtained by integrating Equation 56 over the angle 0-360 degrees. It is found that the averaged loss of light intensity has the following form:

$$\frac{{I}_{AVE}}{{I}_{0}} = \frac{{sin}^{2} π ( \frac{{R}_{1} + {R}_{2}}{λ} ) + {sin}^{2} π ( \frac{{R}_{1} - {R}_{2}}{λ} )}{2} \qquad ( 57 )$$

Equation 57 shows that the averaged light intensity loss can be calculated with Equation 56 at angle of 45 degree. It also shows that light loss in the film+disc assemble is smaller that disc+disc assembly due to the subtraction effect at optical orientation angle of 90 degree. While in the disc+disc assembly, there is only addition effect.

The equivelant or apparent retardation can be used to characterize a two-layer assembly. It can be defined as the loss of light intensity of the two-layer assembly is equal to that of a single layer with equivelant retardation as shown in Equation 58.

$$\frac{{}^{I} loss - 2}{{I}_{0}} = {sin}^{2} \frac{{}^{π R} Equ}{λ} = {cos}^{2} {γsin}^{2} π ( \frac{{R}_{1} + {R}_{2}}{λ} ) + {sin}^{2} {γsin}^{2} π ( \frac{{R}_{1} - {R}_{2}}{λ} ) \qquad ( 58 )$$

The equivelant retardation can be obtained as follows:

$${R}_{equ} = \frac{λ an cos W}{2 π} \qquad ( 59 )$$

where

$$W = {cos}^{2} γcos \frac{2 π ( R1 + R2 )}{λ} + {sin}^{2} γcos \frac{2 π ( R1 - R2 )}{λ} \qquad ( 60 )$$

FIG. 8 shows an example of equivelant retardation of the assembly as function of optical orientation angle. One can see the modulation of the retardation with max occurring at nπ degree (where n=0, 1, 2.).

The averaged equivalent retardation can be calculated using Equation 59 and 60 at angle of 45 degree. Table I shows the comparison of the assembly retardation for film+disc and disc+disc systems. One can see that the apparent assembly retardation in film+disc system is much smaller than the disc+disc system. This means that for the same birefringence of each layer, the light loss in the film+disc assembly is smaller than the disc+disc assembly, due to the cancellation effect in the film+disc system. This also implies that larger film birefringence is allowed to achieve the same light intensity loss as compared to a disc+disc assembly. For example, light loss in the assembly of 90 nm film+50 nm disc is equal to that in the 50 nm disc+50 nm disc. This means that the tolerance of the film birefringence can be inflated as compared to the disc+disc assembly. Table II shows for the same light loss of the assembly, the allowed film retardation (R2 film) is much larger than that of the disc retardation (R2 disc) for a given retardation of the first layer (R1 disc).

TABLE I
Averaged Equivalent Birefringence of 2-layer assembly

| R(film), nm | R(disk), nm | R(film + disk), nm | R(disk + disk), nm |
|---|---|---|---|
| 10 | 10 | 14 | 20 |
| 20 | 20 | 28 | 40 |
| 50 | 50 | 70 | 100 |
| 70 | 70 | 96 | 140 |
| 100 | 100 | 133 | 200 |

TABLE II
Comparison of film retardation (R2) and disc retardation (R2) at
various retardation of first layer (R1) to give same light loss

| R1(disc), nm | R2(disc), nm | R2(film), nm | % light loss |
|---|---|---|---|
| 10 | 10 | 17 | 0.7 |
| 20 | 20 | 35 | 2.6 |
| 50 | 50 | 89 | 15.4 |
| 70 | 70 | 129 | 28.6 |
| 100 | 100 | 202 | 52 |

The above described analysis of the effect of optical axis orientation on light intensity loss due to birefringence of the substrate in a typical CD/DVD optical pickup system show that a double layer polycarbonate substrate assembly is superior to a single polycarbonate substrate layer. For the single layer system, it is shown that the loss of light intensity with polarization perpendicular to the original light does not depend on the sample optical axis orientation with respect to the optical axis of the quarter wavelength plate.

For the double layer assembly, the loss of light intensity depends on the optical axis orientation angle between the two layers in addition to the retardation of the first and second layers. The birefringence is additive when the optical axes of the two layers are parallel. When the optical axes are perpendicular to each other, the assembly birefringence reaches the minimum due to the cancellation effect. It also shows that the light loss in a disc+film assembly is smaller than that in a disc+disc assembly, due to the fact that the angle between the optical axes in film+disc assembly varies continuously from 0 to 360 degree.

While the invention has been described in terms of various specific embodiments, those skilled in the art will recognize that the invention can be practiced with modification within the spirit and scope of the claims.

What is claimed is:

1. A method of producing a polycarbonate film for optical recording media, the polycarbonate film comprising a plurality of layers said method comprising:
arranging the plurality of layers so that a principal optical axis of a first layer is at an angle greater than zero degrees from a principal optical axis of a second layer.

2. A method in accordance with claim 1 further comprising laminating said arranged plurality of layers to form a polycarbonate film.

3. A method in accordance with claim 1 wherein the polycarbonate film comprises a first extruded polycarbonate film layer and a second extruded polycarbonate film layer.

4. A method in accordance with claim 3 wherein arranging the plurality of layers comprises arranging the first and second extruded polycarbonate film layers so that a principal optical axis of the first layer is substantially perpendicular to a principal optical axis of the second layer.

5. A method in accordance with claim 1 wherein the polycarbonate film comprises a first injection molded disc layer and a second extruded polycarbonate film layer, the first injection molded disc layer having a plurality of primary optical axes extending radially from a center of the disc layer.

6. A method in accordance with claim 5 wherein arranging the plurality of layers comprises arranging the first injection molded disc layer and the second extruded polycarbonate film layer so that an angle between a-principal optical axis of the first layer and the principal optical axis of the second layer varies continuously from 0 to 360 degrees.

7. A method of modulating birefringence in a polycarbonate film for optical recording media, the polycarbonate film comprising a plurality of layers said method comprising:
laminating the plurality of layers so that a principal optical axis of a first layer is at an angle greater than zero degrees from a principal optical axis of a second layer.

8. A method in accordance with claim 7 wherein the polycarbonate film comprises a first extruded polycarbonate film layer and a second extruded polycarbonate film layer.

9. A method in accordance with claim 8 wherein laminating the plurality of layers comprises laminating the first and second extruded polycarbonate film layers so that a principal optical axis of the first layer is substantially perpendicular to a principal optical axis of the second layer.

10. A method in accordance with claim 7 wherein the polycarbonate film comprises a first injection molded disc layer and a second extruded polycarbonate film layer, the first injection molded disc layer having a plurality of primary optical axes extending radially from a center of the disc layer.

11. A method in accordance with claim 10 wherein laminating the plurality of layers comprises laminating the first injection molded disc layer and the second extruded polycarbonate film layer so that an angle between a principal optical axis of the first layer and the principal optical axis of the second layer varies continuously from 0 to 360 degrees.

12. A method of producing a polycarbonate film having a controlled birefringence for optical recording media, the polycarbonate film comprising a plurality of layers said method comprising:
laminating a first extruded polycarbonate film layer to a second extruded polycarbonate film layer so that a principal optical axis of the first film layer is at an angle greater than zero degrees from a principal optical axis of the second film layer.

13. A method in accordance with claim 12 wherein laminating a first extruded polycarbonate film layer to a second extruded polycarbonate film layer comprises laminating a first extruded polycarbonate film layer to a second extruded polycarbonate film layer so that the principal optical axis of the first film layer is substantially perpendicular to the principal optical axis of the second film layer.

14. A method of producing a low birefringence polycarbonate film for optical recording media, the polycarbonate film comprising a plurality of layers said method comprising:
laminating a first injection molded disc layer and a second extruded polycarbonate film layer so that an angle between a principal optical axis of the first layer and a principal optical axis of the second layer varies continuously from 0 to 360 degrees.

15. A polycarbonate film for optical recording media, said polycarbonate film having a controlled birefringence and comprising a plurality of layers, said plurality of layers configured so that a principal optical axis of a first layer is at an angle greater than zero degrees from a principal optical axis of a second layer.

16. A polycarbonate film in accordance with claim 15 wherein said plurality of layers comprise a first extruded polycarbonate film layer and a second extruded polycarbonate film layer, said first and second extruded polycarbonate film layers arranged so that a principal optical axis of the first extruded film layer is at an angle greater than zero degrees from a principal optical axis of the second extruded layer.

17. A polycarbonate film in accordance with claim 16 wherein said first and second extruded polycarbonate film layers are arranged so that said principal optical axis of said first film layer is substantially perpendicular to said principal optical axis of said second film layer.

18. A polycarbonate film in accordance with claim 15 wherein said plurality of layers comprise a first injection molded disc layer and a second extruded polycarbonate film layer, said first injection molded disc layer having a plurality of primary optical axes extending radially from a center of said injection molded disc layer, said first injection molded disc layer and said second extruded polycarbonate film layer arranged so that an angle between a principal optical axis of said first injection molded disc layer and a principal optical axis of said second extruded film layer varies continuously from 0 to 360 degrees.
